(19) United States
(12) Patent Application Publication
(10) Pub. No.: US 2009/0138720 A1
(43) Pub. Date: May 28, 2009

(54) METHOD AND APPARATUS FOR DETECTING MOVEMENT OF DOWNLOADABLE CONDITIONAL ACCESS SYSTEM HOST IN DCAS NETWORK

(76) Inventors: Young Ho JEONG, Daejeon (KR); Han Seung KOO, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/191,347

(22) Filed: Aug. 14, 2008

(30) Foreign Application Priority Data
Nov. 26, 2007 (KR) 10-2007-0120781

(51) Int. Cl. H04L 9/06

(52) U.S. Cl. 713/176

(57) ABSTRACT

A method of operating a Secure Micro (SM) of a host in a Conditional Access (CA) system is provided. The method includes: receiving, by the SM, a SecurityAnnounce message including a certificate of an AP server connected with a host; determining, by the SM, whether a public key stored in a memory in advance exists, and setting a flag as a first state when the public key stored in advance exists; verifying, by the SM, a digital signature with respect to the SecurityAnnounce message using the public key stored in advance; and acquiring, by the SM, another public key of the AP server by parsing the certificate and setting the flag as a second state based on whether the flag corresponds to the first state when the SM is unable to verify the digital signature.

### CROSS-REFERENCE TO RELATED APPLICATION

This application claims priority from Korean Patent Application No. 10-2007-0120781, filed on Nov. 26, 2007, in the Korean Intellectual Property Office, the entire disclosure of which is incorporated herein by reference.

### BACKGROUND OF THE INVENTION

1. Field of the Invention

The present invention relates to a technology by which a host having mobility in a Conditional Access (CA) system can efficiently detect movement of an Authentication Proxy (AP) server network using a digital signature.

This work was supported by the IT R&D program of MIC/IITA [2007-S-007-01, The Development of Downloadable Conditional Access System].

2. Description of Related Art

A Conditional Access (CA) system in a cable network is a system for determining, based on user authentication, whether a service is permitted, and allowing only permitted users to receive a program when users intend to watch a specific program.

Since initial CA systems respectively uses different standards depending on each manufacturing company, initial CA systems are incompatible with devices other than a device of a specific manufacturer. Accordingly, since a broadcasting service provider must directly provide subscribers (members) with receiving terminals, burdens on the broadcasting service provider are heavy, and updating the CA system is difficult.

In order to solve the above-described problem, OpenCable of North America announced a standard of separating a CA module from a member terminal. This is for preventing a device manufacturer from monopolizing the market, and for promoting competition, thereby inducing product prices to fall. The CA module separated from the terminal is standardized into a cable card of a Personal Computer Memory Card International Association (PCMCIA) card type, and the broadcasting service provider may provide a paid broadcasting service by providing the subscribers with only cable cards without lending the terminals to the members, similar to the previous scheme. However, since a price of the cable card rises, management cost increases, and a retail market of the terminals is diminished, a result desired by OpenCable is not accomplished.

In this situation, a Downloadable Conditional Access System (DCAS)-related technology of enabling the paid broadcasting service by downloading CA software to a member terminal without separately requiring a hardware CA module is introduced.

A DCAS headend system downloads CA software to a authenticated host accessing to a corresponding network and the host installs the downloaded software in the host. The user may watch a program by receiving program access authority information provided by a CA system server using the installed software.

The host accessing a DCAS network performs mutual authentication with an Authentication Proxy (AP) server in the DCAS headend system using a DCAS message. The DCAS message is digitally signed. The host may acquire, from a SecurityAnnounce message, a public key necessary for verifying a digital signature being information necessary for verifying the digital signature with respect to the DCAS message. The public key is included in a certificate for verifying validity of the public key.

When the host moves from a network of AP server 1 to a network of AP server 2, the host may have a public key of DCAS network 1, and may not easily acquire a public key of AP server 2. Accordingly, when the host uses a public key of AP server 1 in the network of AP server 2, the host may not properly receive the service.

Therefore, a technology of supporting mobility of the host is required.

### SUMMARY OF THE INVENTION

An aspect of the present invention provides a method and apparatus of detecting movement of a host in a Downloadable Conditional Access System (DCAS) network which can automatically detect movement of the host and acquire a public key of a currently-accessed Authentication Proxy (AP) server.

Another aspect of the present invention also provides a method and apparatus of detecting network movement of a host in a DCAS which can efficiently update an included public key into a public key of a currently-accessed AP server.

According to an aspect of the present invention, there is provided an apparatus for supporting host mobility in a Conditional Access (CA) system, the apparatus including: a message receiving unit to receive a SecurityAnnounce message including a certificate of an AP server connected with a host; a public key extraction unit to extract a public key of the AP server by parsing the certificate of the AP server, or to extract a second public key stored in a memory in advance based on whether the second public key stored in the memory in advance exists; and a digital signature verification unit to verify a digital signature with respect to the SecurityAnnounce message using any one of the extracted public key of the AP server and the second extracted public key stored in advance.

According to another aspect of the present invention, there is provided a Secure Micro (SM) of a host in a CA system, the SM including: an authentication request receiving unit to receive, from an SM bootloader, a request for authentication with respect to a SecurityAnnounce message including a certificate of an AP server; a scanner to scan a memory and to determine whether a public key stored in the memory in advance exists; a key extraction unit to extract a second public key of the AP server by parsing the certificate of the AP server, or to extract the public key stored in advance based on a result of the determining of the scanner; and an update unit to update a database based on the second public key of the AP server when the second public key of the AP server is extracted from the key extraction unit.

According to still another aspect of the present invention, there is provided a method of operating an SM of a host in a CA system, the method including: receiving, by the SM, a SecurityAnnounce message including a certificate of an AP server connected with a host; determining, by the SM, whether a public key stored in a memory in advance exists, and setting a flag as a first state when the public key stored in advance exists; verifying, by the SM, a digital signature with respect to the SecurityAnnounce message using the public key stored in advance; and acquiring, by the SM, another public key of the AP server by parsing the certificate and setting the flag as a second state based on whether the flag corresponds to the first state when the SM is unable to verify the digital signature.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 illustrates a case where a host moves from a network of Authentication Proxy (AP) server 1 to a network of AP server 2 according to an exemplary embodiment of the present invention;

FIG. 2 illustrates SecurityAnnounce message 2 and a digital signature being transmitted from AP server 2 according to an exemplary embodiment of the present invention;

FIG. 3 illustrates SecurityAnnounce message 2 and a digital signature being received by a host according to an exemplary embodiment of the present invention;

FIG. 4 is a flowchart illustrating a method of operating a Secure Micro (SM) of a host in a Conditional Access (CA) system according to an exemplary embodiment of the present invention;

FIG. 5 is a block diagram illustrating an SM of a host in a CA system according to an exemplary embodiment of the present invention;

FIG. 6 is a block diagram illustrating an apparatus for supporting host mobility in a CA system according to an exemplary embodiment of the present invention; and

FIG. 7 illustrates acquiring of a public key included in a host according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

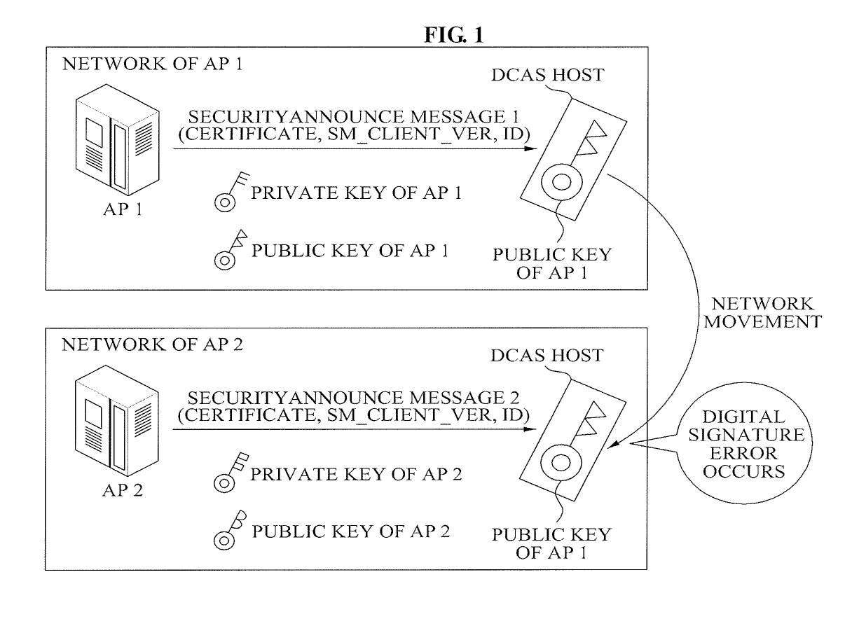

FIG. 1 illustrates a case where a host moves from a network of Authentication Proxy (AP) server 1 to a network of AP server 2 according to an exemplary embodiment of the present invention.

Referring to FIG. 1, the network of AP server 1 includes AP server 1, and the network of AP server 2 includes AP server 2.

The host accesses the network of AP server 1 and receives SecurityAnnounce message 1 from AP server 1. SecurityAnnounce message 1 includes a certificate of AP server 1, version information of a Secure Micro (SM) client (SM_Client_Ver), and Identification (ID) information of AP server 1. SecurityAnnounce message 1 is digitally signed using a private key of AP server 1.

The host performs a digital signature verification process with respect to a SecurityAnnounce message using a public key of AP server 1, and verifies the version information of the SM client, thereby determining whether the SM client is downloaded.

The public key of AP server 1 may be acquired by parsing the certificate of AP server 1. When the host accesses the network of AP server 1 and acquires the public key of AP server 1, the host does not update the public key of AP server 1 each time the host receives SecurityAnnounce message 1 in order to reduce overhead. After the public key of AP server 1 is initially acquired, the host does not parse the certificate of AP server 1 each time the host receives SecurityAnnounce message 1, and verifies a digital signature with respect to SecurityAnnounce message 1 using the acquired public key of AP server 1.

When the host moves from the network of AP server 1 to the network of AP server 2, a digital signature error may occur. AP server 2 transmits, to the host, SecurityAnnounce message 2 digitally signed by a private key of AP server 2. The host must acquire a public key of AP server 2 in order to verify a digital signature with respect to SecurityAnnounce message 2. However, since the host has the public key of AP server 1 acquired by the network of AP server 1, the signature error occurs when the host verifies the digital signature with respect to SecurityAnnounce message 2.

Accordingly, since digital signature verification with respect to SecurityAnnounce message 2 fails, the host may not download the appropriate SM client, and may not receive a cable broadcasting service.

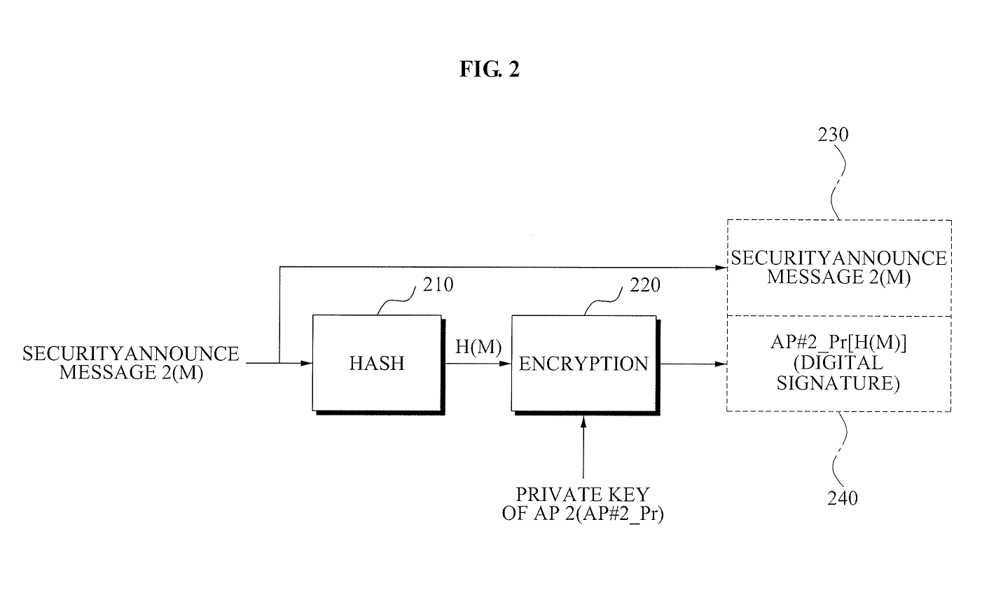

FIG. 2 illustrates SecurityAnnounce message 2 (M) 230 and a digital signature 240 being transmitted from AP server 2 according to an exemplary embodiment of the present invention.

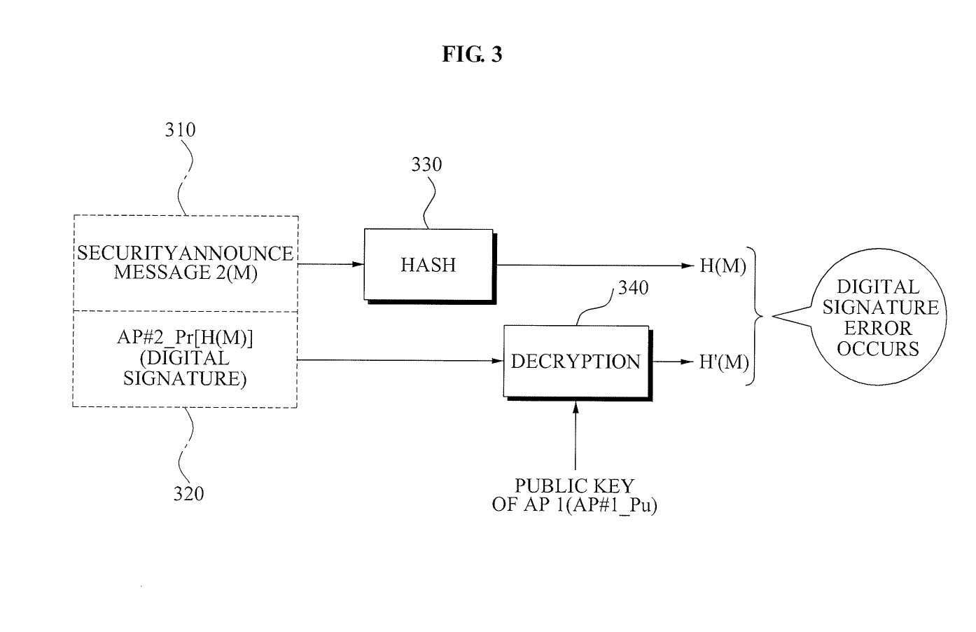

FIG. 3 illustrates SecurityAnnounce message 2 (M) 310 and a digital signature AP#2_Pr[H(M)] 320 being received by a host including a public key of AP server 1 when the host moves to another network according to an exemplary embodiment of the present invention.

Referring to FIG. 2, SecurityAnnounce message 2 (M) is digitally signed (AP#2_Pr[H(M)]) and is transmitted to a host.

In this instance, SecurityAnnounce message 2 (M) is transformed by a hash function into H(M) using a hash block 210. H(M) is encrypted by a private key of AP server 2 (AP#2_Pr) using an encryption block 220, and a digital signature AP#2_Pr[H(M)] 240 is generated. SecurityAnnounce message 2 (M) 230 is attached to the generated digital signature and is transmitted to the host using a network of an AP server.

Referring to FIG. 3, the host receives SecurityAnnounce message 2 (M) 310 and a digital signature AP#2_Pr[H(M)] 320.

The host transforms received SecurityAnnounce message 2 (M) 310 into H(M) using a hash block 330. The host decrypts the received digital signature AP#2_Pr[H(M)] 320 by a public key of AP server 1 (AP#1_Pu) acquired by a network of AP server 1. The digital signature AP#2_Pr[H(M)] 320 is decrypted by the public key of AP server 1 (AP#1_Pu), and H′(M) is generated.

The host compares H(M) generated by the hash block 330 and H′(M) generated by a decryption block 340. Since H(M) and H′(M) are different from each other, the host discards received SecurityAnnounce message 2 (M) 310. Accordingly, the host may not update or download an SM client necessary for a network of AP server 2, and may not receive a cable broadcasting service.

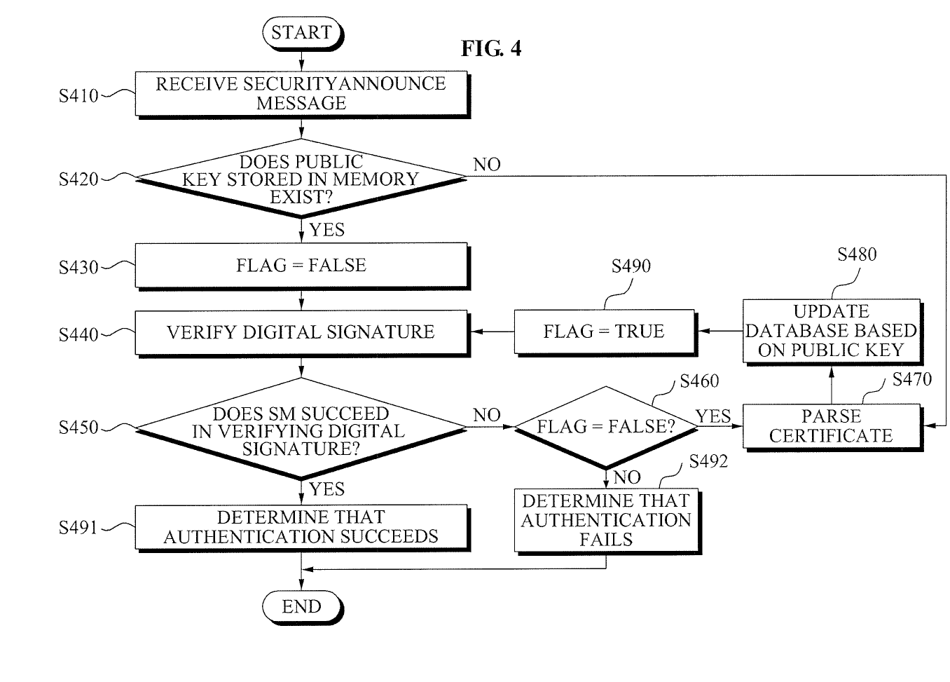

FIG. 4 is a flowchart illustrating a method of operating an SM of a host in a Conditional Access (CA) system according to an exemplary embodiment of the present invention.

Referring to FIG. 4, in operation S410, the SM according to an exemplary embodiment of the present invention receives a SecurityAnnounce message including a certificate of an AP server currently connected with the host. The host may be a host moving after accessing a network of another AP server.

In operation S420, the SM according to an exemplary embodiment of the present invention determines whether a public key stored in a memory in advance exists. When the public key stored in the memory in advance exists, the SM succeeds in verifying a digital signature with respect to the SecurityAnnounce message of the AP server when the host does not move and intentional transformation of the SecurityAnnounce message does not exist.

In operation S430, when it is determined that the public key stored in the memory in advance exists, the SM according to an exemplary embodiment of the present invention sets a state of a flag as false.

In operation S440, when it is determined that the public key stored in the memory in advance exists, the SM according to an exemplary embodiment of the present invention verifies the digital signature with respect to the SecurityAnnounce message using the public key stored in advance.

In operation S491, when the SM succeeds in verifying the digital signature in operation S440, the SM according to an exemplary embodiment of the present invention determines that authentication with respect to the SecurityAnnounce message succeeds. Therefore, the SM according to an exemplary embodiment of the present invention performs subsequent process including downloading an SM client and the like.

Therefore, according to an exemplary embodiment of the present invention, when the public key stored in the memory in advance exists and the SM succeeds in verifying the digital signature using the public key stored in advance, a process of acquiring the public key may not be performed each time the SecurityAnnounce message is received.

In operation S470, when it is determined that the public key stored in the memory in advance does not exist, the SM according to an exemplary embodiment of the present invention parses a certificate included in the SecurityAnnounce message. The SM acquires the public key of the currently-accessed AP server by parsing the certificate.

In operation S480, the SM according to an exemplary embodiment of the present invention updates a database based on the acquired public key. The acquired public key is updated by the database, and is maintained and managed.

In operation S490, the SM according to an exemplary embodiment of the present invention updates the database based on the public key of the AP server acquired by parsing the certificate, and changes the state of the flag into a true state.

In operation S440, the SM according to an exemplary embodiment of the present invention verifies the digital signature with respect to the SecurityAnnounce message after performing operations S470 through S490.

In operation S460, when the SM according to an exemplary embodiment of the present invention fails in verifying the digital signature in operation S450, the SM determines whether the state of the flag is a false state. When the state of the flag is the false state, the SM according to an exemplary embodiment of the present invention performs operations S470 through S490.

Conversely, when the state of the flag is not the false state, it may be determined that intentional transformation exists in the received SecurityAnnounce message. In operation S492, when the state of the flag is not the false state in operation S460, the SM according to an exemplary embodiment of the present invention determines that the authentication fails. Since the state of the flag is not the false state, the public key stored in the memory in advance does not exist, and the SM fails in verifying the digital signature using the acquired public key of the AP server by parsing the certificate.

As described above, according to an exemplary embodiment of the present invention, since a need for acquiring the public key by parsing the certificate each time the SecurityAnnounce message is received when the public key stored in the memory in advance exists, unnecessary operations may be minimized. According to an exemplary embodiment of the present invention, since the public key of the AP server may be automatically acquired by parsing the certificate based on whether the public key stored in the memory in advance exists and whether the SM succeeds in verifying the digital signature, a change based on mobility of the host may be actively dealt with.

The method of operating the SM of the host in the CA system according to the above-described exemplary embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

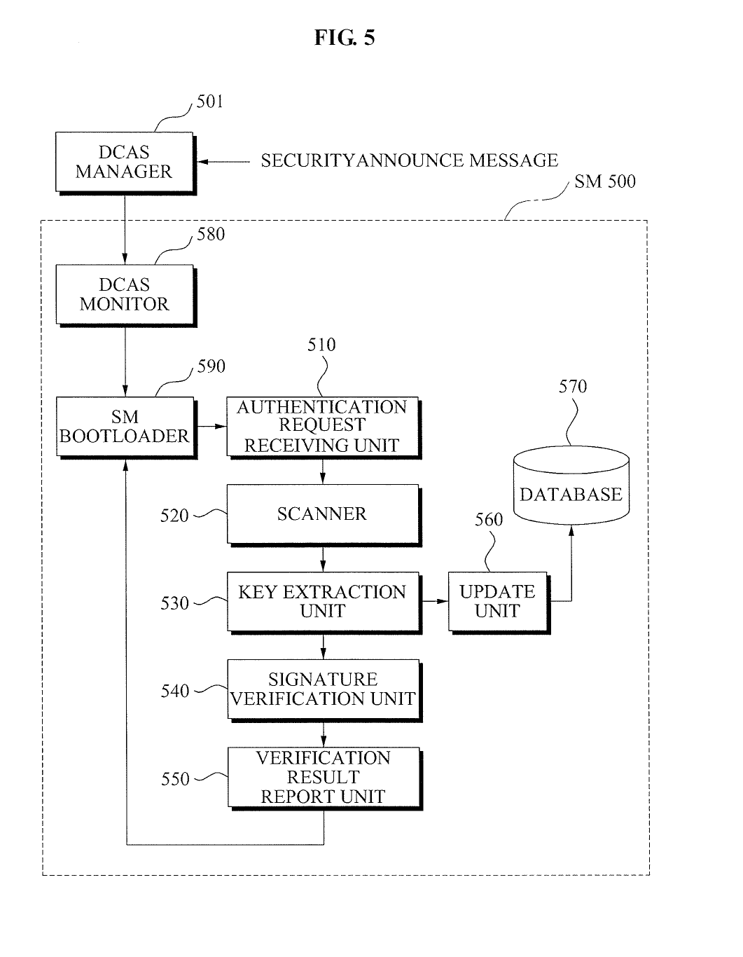

FIG. 5 is a block diagram illustrating an SM 500 of a host in a CA system according to an exemplary embodiment of the present invention.

Referring to FIG. 5, the SM 500 according to an exemplary embodiment of the present invention includes an authentication request receiving unit 510, a scanner 520, a key extraction unit 530, a signature verification unit 540, a verification result report unit 550, an update unit 560, a database 570, a Downloadable Conditional Access System (DCAS) monitor 580, and an SM bootloader 590.

A DCAS manager 501 included in the host receives a SecurityAnnounce message using a Data Over Cable Service Interface Specifications (DOCSIS) Settop Gateway (DSG), and transmits the received SecurityAnnounce message to the DCAS monitor 580 of the SM 500.

The DCAS monitor 580 transmits various messages to an appropriate configuration module in the SM 500. The DCAS monitor 580 transmits the SecurityAnnounce message to the SM bootloader 590. The SM bootloader 590 having received the SecurityAnnounce message requests the authentication request receiving unit 510 to authenticate the SecurityAnnounce message. The scanner 520 scans a memory and determines whether a public key stored in the memory in advance exists.

The key extraction unit 530 extracts a second public key of an AP server by parsing a certificate of the AP server, or extracts the public key stored in advance based on a result of the determining of the scanner 520.

When the public key stored in the memory in advance does not exist, the key extraction unit 530 extracts the second public key of the AP server by parsing the certificate of the AP server, and when the public key stored in the memory in advance exists, the key extraction unit 530 extracts the public key stored in advance from the memory.

The signature verification unit 540 verifies a digital signature with respect to the SecurityAnnounce message using any one of the extracted public key stored in advance and the second extracted public key of the AP server.

When the signature verification unit 540 is unable to verify the digital signature with respect to the SecurityAnnounce message based on the public key stored in advance, the signature verification unit 540 controls the key extraction unit 530 to enable the public key extraction unit 530 to extract the second public key of the AP server by parsing the certificate of the AP server.

The verification result report unit 550 reports a verification result of the signature verification unit 540 to the SM bootloader 590 in response to the request of the SM bootloader 590.

The update unit 560 updates the database 570 based on the second public key of the AP server when the second public key of the AP server is extracted from the key extraction unit 530.

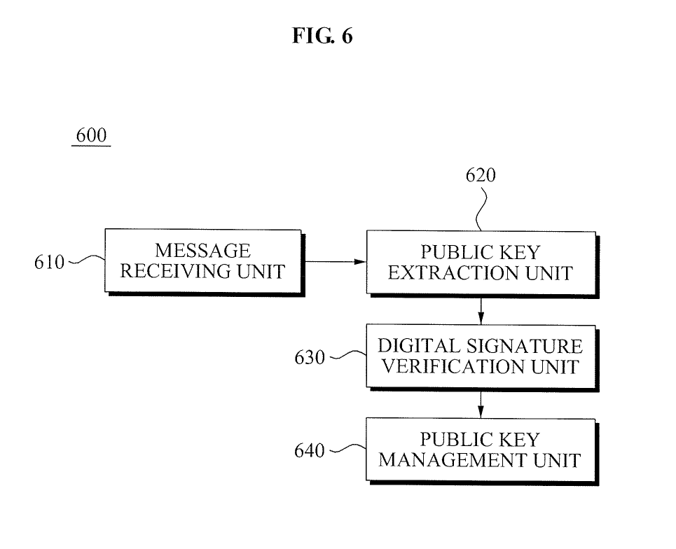

FIG. 6 is a block diagram illustrating an apparatus 600 for supporting host mobility in a CA system according to an exemplary embodiment of the present invention.

Referring to FIG. 6, the apparatus 600 for supporting host mobility in the CA system according to an exemplary embodiment of the present invention includes a message receiving unit 610, a public key extraction unit 620, a digital signature verification unit 630, and a public key management unit 640.

The message receiving unit 610 receives a SecurityAnnounce message including a certificate of an AP server connected with a host. The certificate is digitally signed using a private key of the AP server corresponding to the public key of the AP server.

The message receiving unit 610 receives the SecurityAnnounce message according to a predetermined transceiving protocol of a CA message. The transceiving protocol may be variously set.

The public key extraction unit 620 extracts a public key of the AP server by parsing the certificate of the AP server, or extracts a second public key stored in a memory in advance based on whether the second public key stored in the memory in advance exists.

When the second public key stored in the memory in advance does not exist, the public key extraction unit 620 extracts the public key of the AP server by parsing the certificate of the AP server, and when the second public key stored in the memory in advance exists, the public key extraction unit 620 extracts the second public key stored in advance.

The digital signature verification unit 630 verifies a digital signature with respect to the SecurityAnnounce message using any one of the extracted public key of the AP server and the second extracted public key stored in advance.

When the digital signature verification unit 630 is unable to verify the digital signature with respect to the SecurityAnnounce message using the second public key stored in advance, the digital signature verification unit 630 controls the public key extraction unit 620 to enable the public key extraction unit 620 to extract the public key of the AP server.

The public key management unit 640 updates a database based on the public key of the AP server when the public key of the AP server is extracted from the public key extraction unit 620.

When a third public key of a second AP server other than the AP server is stored in the database, the public key management unit 640 deletes the third public key of the second AP server and stores the public key of the AP server in the database.

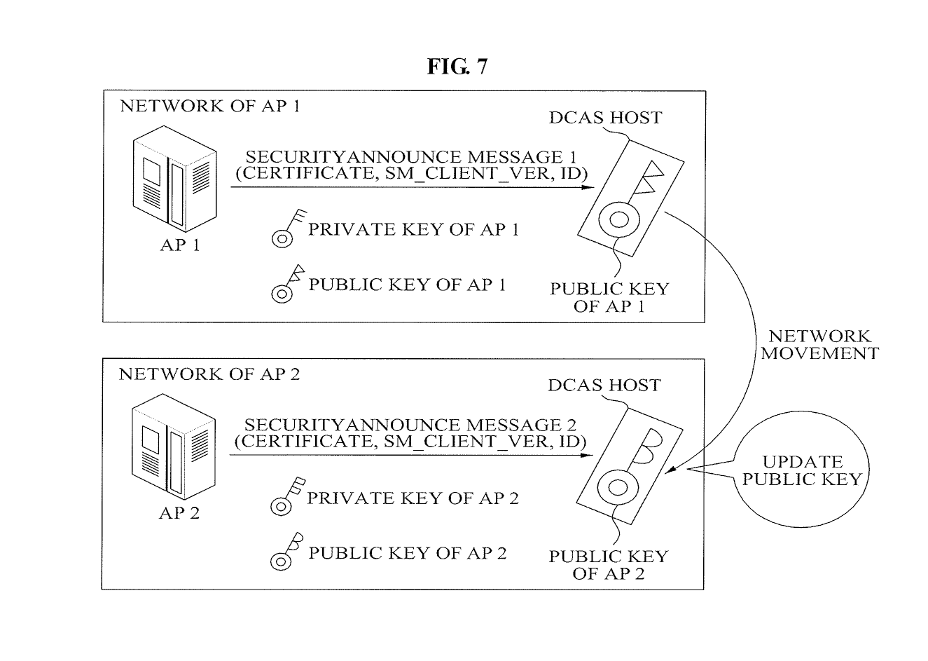

FIG. 7 illustrates acquiring of a public key included in a host according to an exemplary embodiment of the present invention.

Referring to FIG. 7, while the host accesses a network of AP server 1, the host acquires the public key of AP server 1. While the host accesses the network of AP server 1, a process of acquiring the public key by parsing the certificate of AP server 1 is not performed each time SecurityAnnounce message 1 is received.

When the host moves from the network of AP server 1 to a network of AP server 2, the host may detect movement of the host, and acquire a public key of AP server 2 according to an exemplary embodiment of the present invention.

Therefore, according to an exemplary embodiment of the present invention, it is possible to minimize operations of acquiring the public key by parsing the certificate and to efficiently update the public key corresponding to movement of the host.

According to the present invention, it is possible to automatically detect movement of a host and acquire a public key of a currently-accessed AP server, thereby providing a seamless CA service.

Also, according to the present invention, it is possible to efficiently update an included public key into a public key of a currently-accessed AP server.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for supporting host mobility in a Conditional Access (CA) system, the apparatus comprising:
a message receiving unit to receive a SecurityAnnounce message including a certificate of an Authentication Proxy (AP) server connected with a host;
a public key extraction unit to extract a public key of the AP server by parsing the certificate of the AP server, or to extract a second public key stored in a memory in advance based on whether the second public key stored in the memory in advance exists; and
a digital signature verification unit to verify a digital signature with respect to the SecurityAnnounce message using any one of the extracted public key of the AP server and the second extracted public key stored in advance.

2. The apparatus of claim 1, wherein, when the digital signature verification unit is unable to verify the digital signature with respect to the SecurityAnnounce message using the second public key stored in advance, the digital signature verification unit controls the public key extraction unit to enable the public key extraction unit to extract the public key of the AP server.

3. The apparatus of claim 1, wherein, when the second public key stored in the memory in advance does not exist, the public key extraction unit extracts the public key of the AP server by parsing the certificate of the AP server, and
when the second public key stored in the memory in advance exists, the public key extraction unit extracts the second public key stored in advance.

4. The apparatus of claim 1, further comprising:
a public key management unit to update a database based on the public key of the AP server when the public key of the AP server is extracted from the public key extraction unit.

5. The apparatus of claim 4, wherein, when a third public key of a second AP server other than the AP server is stored in the database, the public key management unit deletes the third public key of the second AP server and stores the public key of the AP server in the database.

6. The apparatus of claim 1, wherein the message receiving unit receives the SecurityAnnounce message according to a predetermined transceiving protocol of a CA message.

7. The apparatus of claim 1, wherein the certificate is digitally signed using a private key of the AP server corresponding to the public key of the AP server.

8. A Secure Micro (SM) of a host in a CA system, the SM comprising:
an authentication request receiving unit to receive, from an SM bootloader, a request for authentication with respect to a SecurityAnnounce message including a certificate of an AP server;
a scanner to scan a memory and to determine whether a public key stored in the memory in advance exists;
a key extraction unit to extract a second public key of the AP server by parsing the certificate of the AP server, or to extract the public key stored in advance based on a result of the determining of the scanner; and
an update unit to update a database based on the second public key of the AP server when the second public key of the AP server is extracted from the key extraction unit.

9. The SM of claim 8, further comprising:
a signature verification unit to verify a digital signature with respect to the SecurityAnnounce message using any one of the extracted public key stored in advance and the second extracted public key of the AP server.

10. The SM of claim 9, further comprising:
a verification result report unit to report a verification result of the signature verification unit to the SM bootloader in response to the request of the SM bootloader.

11. The SM of claim 9, wherein, when the signature verification unit is unable to verify the digital signature with respect to the SecurityAnnounce message using the public key stored in advance, the signature verification unit controls the key extraction unit to enable the key extraction unit to extract the second public key of the AP server by parsing the certificate of the AP server.

12. A method of operating an SM of a host in a CA system, the method comprising:
receiving, by the SM, a SecurityAnnounce message including a certificate of an AP server connected with a host;
determining, by the SM, whether a public key stored in a memory in advance exists, and setting a flag as a first state when the public key stored in advance exists;
verifying, by the SM, a digital signature with respect to the SecurityAnnounce message using the public key stored in advance; and
acquiring, by the SM, another public key of the AP server by parsing the certificate and setting the flag as a second state based on whether the flag corresponds to the first state when the SM is unable to verify the digital signature.

13. The method of claim 12, further comprising:
updating, by the SM, a database based on the second public key of the AP server when the second public key of the AP server is extracted.

14. The method of claim 12, further comprising:
acquiring, by the SM, the second public key of the AP server by parsing the certificate, and setting the flag as the second state when the public key stored in the memory in advance does not exist.

15. The method of claim 12, wherein, when the flag corresponds to the first state, the acquiring and setting acquires the second public key of the AP server by parsing the certificate, and changes the flag into the second state.
